(19) United States
(12) Patent Application Publication
(10) Pub. No.: US 2006/0215723 A1
(43) Pub. Date: Sep. 28, 2006

(54) Window structure semiconductor laser device and manufacturing method therefor

(75) Inventor: Masanori Watanabe, Nara-shi (JP)

Correspondence Address: MORRISON & FOERSTER LLP, 1650 TYSONS BOULEVARD, SUITE 300, MCLEAN, VA, 22102, US

(73) Assignee: SHARP KABUSHIKI KAISHA, Osaka (JP)

(21) Appl. No.: 11/385,666

(22) Filed: Mar. 22, 2006

(30) Foreign Application Priority Data
Mar. 24, 2005 (JP) 2005-085903

(51) Int. Cl. H01S 3/08

(52) U.S. Cl. 372/103

(57) ABSTRACT

An AlGaInP based window structure semiconductor laser device of the present invention has an optical waveguide in which a lower cladding layer, an active layer having a quantum well layer, and an upper cladding layer are laminated in this order and which emits light from a light-emitting end surface that is formed on an end of the optical waveguide. A window portion having an active layer in which the quantum well layer is disordered is formed in an end portion including the light-emitting end surface in the optical waveguide. A light intensity distribution in a vertical direction for the laminated layers in the window portion spreads further than a light intensity distribution in the vertical direction in a non-window portion which is adjacent to the window portion inside the optical waveguide. A length of the window portion from the light-emitting end surface to the non-window portion is not smaller than 48 μm and not greater than 80 μm.

### CROSS-REFERENCE TO RELATED APPLICATIONS

This Nonprovisional application claims priority under 35 U.S.C. §119(a) on Patent Application No. 2005-085903 filed in Japan on Mar. 24, 2005, the entire contents of which are hereby incorporated by reference.

### BACKGROUND OF THE INVENTION

The present invention relates to window structure semiconductor laser devices and manufacturing methods therefor and relates, in particular, to a window structure semiconductor laser device capable of operating with a high output suitable for use in writing data into an optical disk such as DVD (Digital Versatile Disc) and reading data from an optical disk (hereinafter referred to as “for optical disk use”) and a manufacturing method therefor.

As a semiconductor laser for optical disk use, an end surface emission type semiconductor laser is normally used. The semiconductor laser for optical disk use needs to have a laser beam capable of obtaining a spot shape as close as possible to the complete circle on an optical disk. However, the spread of the emitted laser beam of the end surface emission type is generally varied between in vertical direction and in horizontal direction. Referring a vertical radiation angle as θv, which is defined corresponding to full width at half maximum of light intensity distribution in vertical direction, and a horizontal radiation angle as θh, which is defined corresponding to full width at half maximum of light intensity distribution in horizontal direction, respectively, then ellipticity is a ratio θv/θh. For example, the ellipticity takes, a value θv/θh=2 when θv=18° and θh=9°.

As described above, since the vertical radiation angle θv is normally larger, in order to form the cross-sectional shape of the laser beam into the complete circular shape, a method for forming an elliptic laser beam into the complete circular shape by means of a shaping prism or the like and a method for forming an elliptic laser beam into the complete circular shape by partially removing the periphery of the laser beam are used. However, the former method has a problem that the introduction of the laser beam shaping means leads to the cost increase of the semiconductor laser. Moreover, the latter method has a problem that the usable laser beam output is reduced since the efficiency of use of the laser beam is reduced.

There is a description of a semiconductor laser of a low ellipticity in JP2002-353566A. FIG. 19 shows a perspective view of the semiconductor laser. An Si-doped GaInP buffer layer 2, an n-type cladding layer 3 made of Si-doped (Al_{0.7}Ga_{0.3})_{0.5}In_{0.5}P, an active layer 4 having an MQW (Multi Quantum Well) layer between two optical guide layers made of (AlₓGa₁₋ₓ)_{0.5}In_{0.5}P, and a p-type first cladding layer 5 and a p-type second cladding layer 6 made of Zn-doped (Al_{0.7}Ga_{0.3})_{0.5}In_{0.5}P are formed on an n-type GaAs substrate 1. A p-type contact layer 7 made of Zn-doped GaInP is formed on it. Moreover, an Se-doped Al_{0.5}In_{0.5}P optical confinement layer 8, an Se-doped GaAs current blocking layer 9 and a p-type GaAs cap layer 10 are formed. The active layer 4 has three quantum well layers of a thickness of 8 nm and two barrier layers of a thickness of 5 nm. Moreover, a Zn diffusion region 13 (window portion) is formed in the neighborhood of the light-emitting end surface and prevents the deterioration of the light-emitting end surface caused by the emission of high power light.

As to the spread of the emitted laser beam 20, as described above, the vertical radiation angle θv in YZ plane of FIG. 19 differs from the horizontal radiation angle θh in XZ plane of FIG. 19. It is noted that the Y-direction of FIG. 19 is the direction perpendicular to the plane in which the layers are formed on the substrate 1, the Z-direction is the direction perpendicular to the light-emitting end surface, and the X-direction is the direction that is parallel to the plane in which the layers are formed on the substrate 1 and perpendicular to the Z-direction.

In JP2002-353566A, it is described that θv can be adjusted from 22.0° to 12.5° by changing the thickness of the optical guide layer made of (AlₓGa₁₋ₓ)_{0.5}In_{0.5}P from 20 nm to 15 nm and changing the Al composition ratio x of the optical guide layer from 0.39 to 0.67. However, as indicated by the current-to-optical output relation of FIG. 20, the oscillation threshold current that is the point at which the optical output rises from zero is increased as θv is reduced. This is because an attempt to reduce θv causes the spread of light in the optical waveguide in the vertical direction and consequently reduces the light intensity in the quantum well layer, making it difficult to cause laser oscillation.

Moreover, in a document “Hitoshi Tada et al., “Uniform Fabrication of Highly Reliable, 50-60 mW-Class, 685 nm, Window-Mirror Lasers for Optical Data Storage”, Japanese Journal of Applied Physics, Volume 36, Part 1, No. 5A, 1997, page 2668, FIG. 6a”, there is a description of a correlation between the window length and the oscillation threshold current in a semiconductor laser. As shown in FIG. 21, it is described that the oscillation threshold current is increased as the window length Lw is increased when the window length Lw is set to 20 μm, 40 μm and 100 μm. According to the knowledge, it is generally considered that the window length should better be as short as possible, and, for example, a window length of 20 μm is described in JP2004-235382A and a window length of 30 μm to 40 μm on the light-emitting end surface side is described in JP2004-87836A.

Furthermore, with regard to the shape of radiation light that can be satisfactorily used for optical disks, it is important not only that the vertical radiation angle θv is small and leads to a small ellipticity but also that an angle between a direction (0°) perpendicular to the light-emitting end surface and a direction of a peak of intensity distribution of radiation light in the vertical direction (an vertical axial deviation angle) φv is little, and the vertical radiation light shape (shape of intensity distribution of radiation light in the vertical direction) is close to a Gaussian distribution shape (described later). However, as described in the prior art of JP2004-235382A, a problem of axial deviation (φv deviation) in the vertical direction such that the peak angle of the spread of the radiation light in the vertical direction has inclined by about 0.5° to 3° toward the n-cladding layer side with respect to the direction (Z-axis direction) perpendicular to the light-emitting end surface in the window structure semiconductor laser has occurred. Moreover, in accordance with this, a problem that the vertical shape of the radiation light has deviated from the Gaussian distribution shape has occurred. The deterioration in the shape of the radiation light has caused a problem that the optical use efficiency has been reduced for use in optical disks and the signal read error in the optical pickup has increased.

### SUMMARY OF THE INVENTION

An increase in the oscillation threshold current has occurred in an attempt to reduce the vertical radiation angle θv in order to reduce the ellipticity of the radiation light in the semiconductor laser having the window structure, and an abrupt increase in the oscillation threshold current has occurred particularly in an attempt to make the vertical radiation angle θv not greater than 15°.

Moreover, in the semiconductor laser having the window structure, the problems of the axial deviation (φv deviation) in the vertical direction and the deviation of the vertical radiation light shape from the Gaussian distribution shape.

It is an object of the present invention to reduce the vertical radiation angle θv while suppressing an increase in the threshold current in order to improve the use efficiency of the radiation light. A further object is to provide a window structure semiconductor laser device, in which the vertical axial deviation angle φv is reduced and the vertical radiation light shape is close to the Gaussian distribution shape.

(1) The present invention is an AlGaInP based window structure semiconductor laser device having an optical waveguide in which a lower cladding layer, an active layer having a quantum well layer, and an upper cladding layer are laminated in this order and which emits light from a light-emitting end surface that is formed on an end of the optical waveguide, wherein

a window portion having an active layer in which the quantum well layer is disordered is formed in an end portion including the light-emitting end surface in the optical waveguide,

a light intensity distribution in a vertical direction for the laminated layers in the window portion spreads further than a light intensity distribution in the vertical direction in a non-window portion which is adjacent to the window portion inside the optical waveguide, and

a length (hereinafter, referred to as “window length”) of the window portion from the light-emitting end surface to the non-window portion is not smaller than 48 μm and not greater than 80 μm.

By thus making the window length longer than the conventional typical window length of 20 μm to 40 μm, the intensity distribution shape of the guided wave in the window portion can be widened by transformation with respect to the intensity distribution shape of the guided wave in the non-window portion. As a result, the vertical radiation angle θv in the window portion can be made smaller than the virtual vertical radiation angle θv when the light-emitting end surface is provided in the non-window portion. Therefore, the vertical radiation angle can further be reduced while suppressing the increase in the oscillation threshold current.

For example, the vertical radiation angle is not smaller than 9° and not greater than 13° when the window length is not smaller than 53 μm and not greater than 80 μm, and this is more desirable since the ellipticity can further be reduced. Moreover, the vertical radiation angle is not smaller than 9° and not greater than 12° when the window length is not smaller than 58 μm and not greater than 80 μm, and this is more desirable since the ellipticity can further be reduced.

(2) Moreover, the present invention is the AlGaInP based window structure semiconductor laser device, wherein a vertical radiation angle which is defined corresponding to full width at half maximum of light intensity distribution in the vertical direction in the non-window portion is greater than a vertical radiation angle (referred to as “θv(non-window portion)”) which is defined corresponding to full width at half maximum of light intensity distribution in the vertical direction of the light emitted from the window portion by not smaller than 3°.

The threshold current of the semiconductor laser becomes lower as θv(non-window portion) in the non-window portion, or the region that actually contributes to light emission becomes greater. Therefore, by making θv(non-window portion) greater than θv by 30 or more, the threshold current of the semiconductor laser can be reduced further than when θv(non-window portion) and θv are equal. Furthermore, a further reduction in the ellipticity can be achieved when θv(non-window portion) is greater than θv by 4° or more, and this is more desirable.

(3) Moreover, the present invention is the AlGaInP based window structure semiconductor laser device, wherein a vertical radiation angle which is defined corresponding to full width at half maximum of light intensity distribution in the vertical direction of the light emitted from the window portion is not smaller than 9° and not greater than 14°.

With this arrangement, the ellipticity becomes 1.4 or less when θh is, for example, 10°, and therefore, a satisfactory beam use efficiency can be obtained without using a shaping means such as a shaping prism. Furthermore, a further reduction in the ellipticity can be achieved when the vertical radiation angle is not smaller than 9° and not greater than 13°, and this is more desirable. Moreover, it is more desirable when the vertical radiation angle is not smaller than 9° and not greater than 12°.

(4) Moreover, the present invention is the AlGaInP based window structure semiconductor laser device, wherein an vertical axial deviation angle between a direction perpendicular to the light-emitting end surface and a direction of a peak of light intensity distribution in the vertical direction of the light emitted from the window portion is within a range from −1° to 1°.

The present inventor discovered that θv is minimized and the vertical axial deviation angle becomes close to zero when the window length is not smaller than 48 μm and not greater than 80 μm, and this is suitable. Furthermore, a further improvement in the beam shape can be achieved when the vertical axial deviation angle is not smaller than −0.5° and not greater than 0.5°, and this is more desirable.

(5) Moreover, the present invention is the AlGaInP based window structure semiconductor laser device, wherein the quantum well layer has a layer thickness of not greater than 6.5 nm.

Although the difference between the refractive index of the MQW layer and the refractive index when the MQW layer is disordered is small when the thickness of the quantum well layer is greater than 6.5 nm, the difference between the two becomes large when the thickness of the quantum well layer is not greater than 6.5 nm. Therefore, it becomes possible to increase the amount of transformation (θv(non-window portion)−θv) of the vertical radiation angle in the window portion. The layer thickness of the quantum well layer should desirably be not greater than 6 nm and more desirably be not greater than 5.5 nm.

(6) Moreover, the present invention is the AlGaInP based window structure semiconductor laser device, wherein a number of the quantum well layers is not smaller than four and not greater than six.

The transformation effect of the guided wave shape can be intensified in the window portion while suppressing the increase in the oscillation threshold value when the number of quantum well layers is within the range, and this is suitable for reducing the vertical radiation angle. For example, the number of the quantum wells should more desirably be not smaller than four and not greater than five.

(7) Moreover, the present invention is the AlGaInP based window structure semiconductor laser device, wherein the lower cladding layer is comprised of a first lower cladding layer located in a portion remote from the active layer and a second lower cladding layer located in a portion near the active layer, and

a photoluminescence wavelength (hereinafter, referred to as “PL wavelength”) of the first lower cladding layer is shorter than a PL wavelength of the second lower cladding layer by not smaller than 2 nm and not greater than 50 nm, and the second lower cladding layer has a thickness of not smaller than 1.5 μm and not greater than 3.5 μm.

With this arrangement, the vertical guided wave shape in the window portion can be shaped even when the vertical radiation angle has a small value of, for example, not greater than 14°. Therefore, the vertical radiation light shape (shape of intensity distribution of radiation light in the vertical direction) can be kept close to the Gaussian distribution shape. Furthermore, the PL wavelength of the first lower cladding layer should desirably be shorter than the PL wavelength of the second lower cladding layer by not smaller than 4 nm and not greater than 50 nm. Furthermore, the thickness of the second lower cladding layer should desirably be not smaller than 2.0 μm and not greater than 3.0 μm.

(8) Moreover, the present invention is the AlGaInP based window structure semiconductor laser device, wherein the lower cladding layer is comprised of a first lower cladding layer located in a portion remote from the active layer and a second lower cladding layer located in a portion near the active layer, and

a PL luminescence wavelength of the first lower cladding layer is shorter than a PL luminescence wavelength of the upper cladding layer by not smaller than 2 nm and not greater than 50 nm.

With this arrangement, the vertical guided wave shape in the window portion can be shaped even when the vertical radiation angle has a small value of not greater than 14°. Therefore, the vertical radiation light shape can be kept close to the Gaussian distribution shape. Furthermore, the PL wavelength of the first lower cladding layer should desirably be shorter than the PL wavelength of the upper cladding layer by not smaller than 3 nm and not greater than 50 nm.

(9) Moreover, the present invention is a method for manufacturing the AlGaInP based window structure semiconductor laser device, comprising:

a step of forming a wafer in which an n-type lower cladding layer, an active layer having a quantum well layer and a p-type upper cladding layer are successively laminated;

a step of forming a p-type dopant diffusion source on a surface of a portion of the wafer where the window portion is to be formed;

a first annealing step of forming the window portion by disordering the active layer that has the quantum well layer by means of diffusion of p-type dopant from the p-type dopant diffusion source;

a step of removing the p-type dopant diffusion source;

a second annealing step of making the p-type dopant diffuse so as to reduce the p-type dopant concentration at least in the active layer of the window portion; and

a step of forming the light-emitting end surface so that the window portion formed by the diffusion of the p-type dopant has a length of not smaller than 48 μm and not greater than 80 μm.

In the previously mentioned document “Hitoshi Tada et al.”, it is described that the oscillation threshold current is increased by increasing the window length. However, in the present invention, by carrying out the second annealing step, the p-type dopant concentration in the active layer in the window portion and its neighborhood is reduced due to diffusion, and the optical absorption loss due to the p-type dopant can be reduced. Therefore, an increase in the oscillation threshold current is suppressed even when the long window portion of not smaller than 48 μm and not greater than 80 μm is provided, and the characteristic deterioration is suppressed.

(10) Moreover, the present invention is a method for manufacturing the AlGaInP based window structure semiconductor laser device, comprising:

a step of forming a wafer in which an n-type lower cladding layer, an active layer having a quantum well layer, a p-type upper cladding layer and a p-type cap layer are successively laminated;

a step of forming a p-type dopant diffusion source on a surface of the p-type cap layer of a portion of the wafer where the window portion is to be formed;

a first annealing step of forming the window portion by disordering the active layer that has the quantum well layer by means of diffusion of p-type dopant from the p-type dopant diffusion source;

a step of removing the p-type dopant diffusion source and the p-type cap layer in the window portion;

a second annealing step of making the p-type dopant diffuse so as to reduce the p-type dopant concentration at least in the active layer of the window portion; and

a step of forming the light-emitting end surface so that the window portion formed by the diffusion of the p-type dopant has a length of not smaller than 48 μm and not greater than 80 μm.

In the previously mentioned document Hitoshi Tada et al., it is described that the oscillation threshold current is increased by increasing the window length. However, in the present invention, by carrying out the second annealing step after the p-type cap layer in the window portion in which the p-type dopant is contained at high concentration is removed after the first annealing step, the p-type dopant concentration in the active layer in the window portion and its neighborhood is reduced due to diffusion, and the optical absorption loss due to the p-type dopant can be reduced. Therefore, an increase in the oscillation threshold current is suppressed even when the long window portion of not smaller than 48 μm and not greater than 80 μm is provided, and the characteristic deterioration is suppressed.

(11) Moreover, the present invention is the method for manufacturing the AlGaInP based window structure semiconductor laser device, wherein the quantum well layer has a layer thickness of not greater than 6.5 nm.

When the quantum well layer thickness is not greater than 6.5 nm, the vertical radiation angle in the window portion can be reduced by using the present manufacturing method.

(12) Moreover, the present invention is the method for manufacturing the AlGaInP based window structure semiconductor laser device, wherein a number of the quantum well layers is not smaller than four and not greater than six.

When the number of the quantum well layers is in the range, the vertical radiation angle in the window portion can be reduced by using the present manufacturing method.

(13) Moreover, the present invention is a method for manufacturing an AlGaInP based window structure semiconductor laser device, wherein a temperature in the second annealing step is not lower than 570° C. and not higher than 850° C.

By carrying out the second annealing step within the temperature range, the p-type dopant in the active layer of the window portion diffuses. On the other hand, due to the range in which the diffusion of the p-type dopant in the active layer of the non-window portion is suppressed, an increase in the oscillation threshold current is suppressed, and a semiconductor laser of satisfactory characteristics can be manufactured. In the case of annealing for one to four hours, an increase in the oscillation threshold characteristic is suppressed when the temperature is not lower than 570° C. and not higher than 750° C., and a semiconductor laser of satisfactory characteristics can be manufactured. Furthermore, in the case of annealing for one to four hours, it is more preferable that the temperature is not lower than 600° C. and not higher than 740° C.

In the present invention, by positively using the effect that the vertical distribution shape of the guided wave is transformed in the window portion when the window length is extended, an increase in the oscillation threshold current is suppressed (a decrease in the light intensity inside the quantum well layer in the non-window portion is suppressed). Moreover, the ellipticity is close to one since the vertical radiation angle has a small value of not smaller than 9° and not greater than 14°, and a semiconductor laser of which the vertical radiation light shape is satisfactory can be provided. Therefore, the semiconductor laser of the present invention is excellent in the optical use efficiency in, for example, optical disks. In accordance with it, a pickup of a simple construction for optical disks is obtained without reducing the use efficiency of the laser beam by virtue of the semiconductor laser of the present invention, and this makes it possible to reduce the size and weight of the optical pickup and achieve a high-speed access.

More preferably, in the present invention, the layer thickness of the quantum well layer is reduced or the number of layers is increased in order to enhance the effect that the vertical distribution shape of the guided wave is transformed when the window length is extended. With this arrangement, the vertical radiation angle can further be reduced.

More preferably, in the present invention, the second annealing is carried out in the state in which the p-type dopant diffusion source is removed subsequently to the first annealing step for the formation of the window portion in order to prevent the increase in the optical absorption loss in the window portion when the window length is extended. In accordance with the arrangement, the optical loss increase when the window length is extended is suppressed.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a top view of a window structure semiconductor laser according to Embodiment 1;

FIG. 2 is a sectional view of the window structure semiconductor laser of Embodiment 1;

FIG. 3 is a sectional view of the window structure semiconductor laser of Embodiment 1 in a manufacturing process;

FIG. 4 is a sectional view of the window structure semiconductor laser of Embodiment 1 in a manufacturing process;

FIG. 5 is a sectional view of the window structure semiconductor laser of Embodiment 1 in a manufacturing process;

FIG. 6 is an explanatory view of the distribution of an Al composition ratio x in the MQW layer in the non-window portion and the window portion and its neighborhood;

FIG. 7 is an explanatory view showing the relation between a second annealing temperature and an oscillation threshold current in Embodiment 1;

FIG. 8 is an explanatory view showing the relation between the Al composition ratio x and the refractive index considered as a reason why the vertical radiation angle in the window portion changes depending on the window length;

FIG. 9 is an explanatory view of the relation between the window length and the vertical radiation angle θv in Embodiment 1;

FIG. 10 is an explanatory view of the relation between the window length and the vertical axial deviation angle φv in Embodiment 1;

FIG. 11 is an explanatory view of the guided wave distribution in the non-window portion and the window portion in Embodiment 1;

FIG. 12 is a simulation result of a vertical radiation light shape in Embodiment 1;

FIG. 13 is an explanatory view of the guided wave distribution in the non-window portion and the window portion in a comparative example for Embodiment 1;

FIG. 14 is a simulation result of the vertical radiation light shape in the comparative example for Embodiment 1;

FIG. 15 is an explanatory view showing the relation between the Al composition ratio x and the refractive index in Embodiment 2;

FIG. 16 is a sectional view of a window structure semiconductor laser according to Embodiment 3 in a manufacturing process;

FIG. 17 is an explanatory view of the relation between the window length and the vertical radiation angle θv in Embodiments 1, 2 and 3;

FIG. 18 is an explanatory view of the relation between the vertical radiation angle θv and the oscillation threshold current Ith in Embodiments 1, 2 and 3 and a prior art example;

FIG. 19 is a perspective view of a prior art window structure semiconductor laser;

FIG. 20 is an explanatory view showing the dependency of the relation between a current and an optical output on the vertical radiation angle in the prior art window structure semiconductor laser; and

FIG. 21 is an explanatory view of the relation between the window length and the oscillation threshold current in the prior art window structure semiconductor laser.

### DETAILED DESCRIPTION OF THE INVENTION

Embodiments of the present invention will be described below. It is noted that the same reference numerals denote same portions or equivalent portions in the accompanying drawings. Moreover, in the present specification, (AlₓGa₁₋ₓ)_{y}In_{1-y}P (note that 0≦x≦1, and 0≦y≦1), Ga_{z}In_{1-z}P (note that 0≦z≦1) and AlᵣGa₁₋ᵣAs (note that 0≦r≦1) are occasionally abbreviated to AlGaInP, GaInP and AlGaAs, respectively.

Numbers that represent the composition ratios are not strict, and the number of 0.5 in the case of Ga_{0.5}In_{0.5}P merely indicates the fact that it falls within a range of almost 0.45 to 0.55. Moreover, even the entry of digits to two decimal places means the set value and sometimes different from the actual value. Moreover, as a method for actually measuring the Al composition ratio of each AlGaInP layer of a semiconductor laser, a PL wavelength (wavelength of light emitted by the photoluminescence method) is measured. The relation between the PL wavelength and the refractive index and the Al composition ratio are calculated by assuming numerical expressions.

### EMBODIMENT 1

(Structure of Semiconductor Laser of Embodiment 1)

The structure of the semiconductor laser of the present embodiment is described. As shown in FIG. 1 that is a schematic top view, in the semiconductor laser of the present embodiment, a ridge region 150, a ridge side region 151 and a terrace region 152 are formed, and light is distributed in a region centered on an undoped MQW layer 106 (described later) located at the ridge region 150 and its neighborhood. A window portion 131 and a window portion 132 are formed within a range of L₁ (60 μm) and L₂ (60 μm) from a light-emitting end surface 155 and a rear end surface 156, respectively, and the other region serves as a non-window portion 133. A front antireflection coating 157 and a rear reflection coating 158 are formed on the light-emitting end surface 155 and the rear end surface 156, respectively.

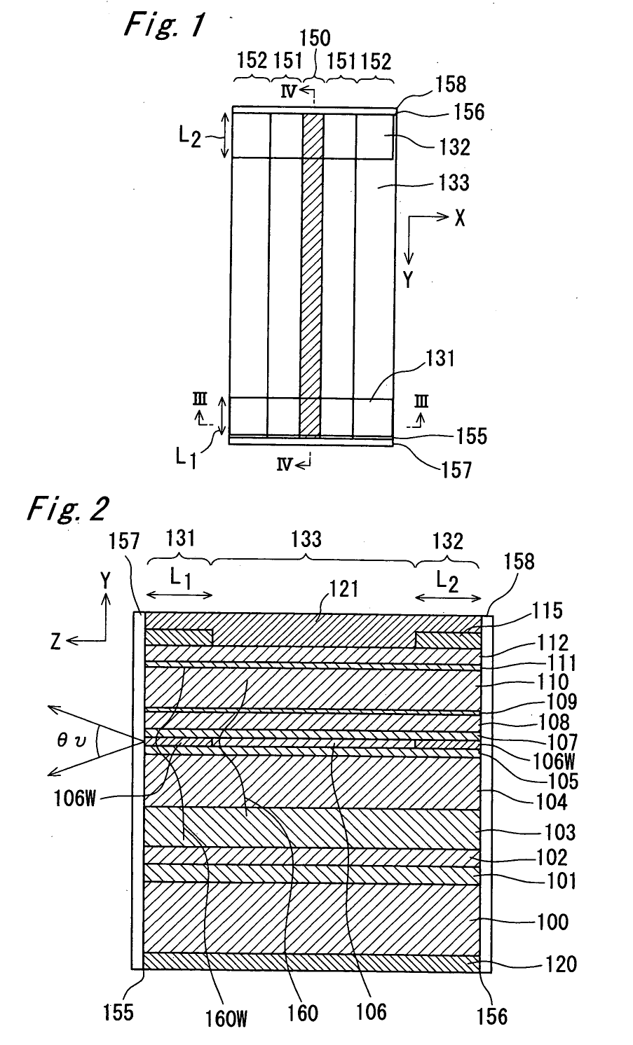

FIG. 2 shows a sectional view taken along the line IV-IV of the semiconductor laser shown in FIG. 1. In the semiconductor laser of the present embodiment, an n-type GaAs buffer layer 101, an n-type Ga_{0.5}In_{0.5}P buffer layer 102, an n-type (Al_{0.68}Ga_{0.32})_{0.5}In_{0.5}P first lower cladding layer 103 (thickness: 1.5 μm), an n-type (Al_{0.64}Ga_{0.36})_{0.5}In_{0.5}P second lower cladding layer 104 (thickness: 2.5 μm), an undoped (Al_{0.52}Ga_{0.48})_{0.5}In_{0.5}P lower guide layer 105 (thickness: 0.01 μm), an undoped MQW (Multi-Quantum Well) layer 106, an undoped (Al_{0.52}Ga_{0.48})_{0.5}In_{0.5}P upper guide layer 107 (thickness: 0.01 μm), a p-type (Al_{0.66}Ga_{0.34})_{0.5}In_{0.5}P first upper cladding layer 108 (thickness: 0.19 μm), a p-type Ga_{0.6}In_{0.4}P etching stop layer 109 (thickness: 0.01 μm), a p-type (Al_{0.66}Ga_{0.34})_{0.5}In_{0.5}P second upper cladding layer 110 (thickness: 1.5 μm), a p-type Ga_{0.5}In_{0.5}P intermediate bandgap layer 111 (thickness: 0.03 μm), a p-type GaAs cap layer 112 (thickness: 0.5 μm) are successively formed on an n-type GaAs substrate 100 in the non-window portion 133. The n-type dopant in the layer 103 and the layer 104 is Si, and it's atomic concentration is 8×10¹⁷ cm⁻³. The p-type dopant in the layer 108 and the layer 110 is Mg, and it's atomic concentration is 1.2×10¹⁸ cm⁻³. The p-type dopant in the layer 111 is Mg, and it's atomic concentration is 2.5×10¹⁸ cm⁻³. The p-type dopant in the layer 112 is Zn, and it's atomic concentration is 1.0×10¹⁹ cm⁻³.

The undoped MQW layer 106 is constituted by inserting three 6-nm thick (Al_{0.52}Ga_{0.48})_{0.5}In_{0.5}P barrier layers (106B, 106D and 106E) between four 5-nm thick Ga_{0.46}In_{0.54}P quantum well layers (106A, 106C, 106E and 106G). The undoped (Al_{0.52}Ga_{0.48})_{0.5}In_{0.5}P lower guide layer 105, the undoped MQW (Multi-Quantum Well) layer 106 and the undoped (Al_{0.52}Ga_{0.48})_{0.5}In_{0.5}P upper guide layer 107 are collectively referred to as an active layer.

In the window portion 131 and the window portion 132, the undoped MQW layer 106 serves as an MQW layer 106W of a disordered window portion. Moreover, an SiO₂ cover layer 115 is formed on the p-type GaAs cap layer 112, so that no current flows through the window portion 131 and the window portion 132. It is noted that the range in the cross sectional direction (Y-direction) of the window portion 131, the window portion 132 and the non-window portion 133 includes the layers ranging from the layer 101 to the layer 115 in FIG. 2.

An n-side electrode 120 is formed by layering an AuGe layer, an Ni layer, an Mo layer and an Au layer in this order from the surface of the n-type substrate 100, while the p-side electrode 121 is formed by layering an AuZn layer, an Mo layer and an Au layer in this order on the p-type cap layer 112 located in the non-window portion 133 and on the SiO₂ cover layer 115 located on the window portion 131 and the window portion 132.

The front antireflection coating 157 (reflectance: 8%) located on the light-emitting end surface 155 is an Al₂O₃ layer, and the rear reflection coating 158 (reflectance: 90%) located on the rear end surface 156 is formed by layering an Al₂O₃ layer, an Si layer, an Al₂O₃ layer, an Si layer and an Al₂O₃ layer in this order from the rear end surface 156. The resonator length (distance from the light-emitting end surface 155 to the rear end surface 156) is 1300 μm.

By flowing a current between an n-side electrode 120 and a p-side electrodes 121, a guided wave 160 which has a peak at the MQW layer 106 is distributed in the non-window portion 133, and a guided wave 160W is distributed in the window portion 131.

(Manufacturing Method of Semiconductor Laser of Embodiment 1)

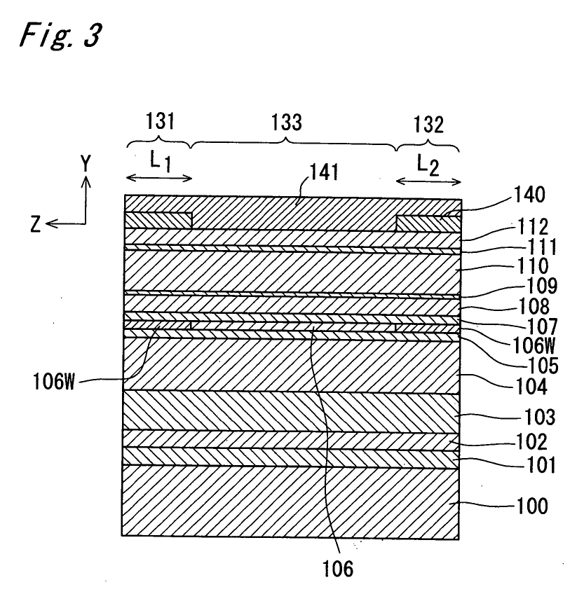

The semiconductor laser of the present embodiment is manufactured as follows. FIG. 3 shows a cross section taken along the line IV-IV of the semiconductor laser shown in FIG. 1 in a manufacturing process. The layers from the n-type GaAs buffer layer 101 to the p-type GaAs cap layer 112 are successively deposited on the n-type GaAs substrate 100 by the MOCVD (Metal Organic Chemical Vapor Deposition) method.

Next, as shown in FIG. 3, a ZnO film 140, which is a p-type dopant diffusion source, and an SiO₂ film 141 that covers the film are formed on the p-type GaAs cap layer 112 in the regions that become the window portion 131 and the window portion 132. In the region that becomes the non-window portion 133, the ZnO film 140 is not provided, but the SiO₂ film 141 is formed directly on the p-type GaAs cap layer 112. In accordance with the movement of the p-type dopant (Mg of the dopant in the first and second upper cladding layers 108 and 110 moved by being induced chiefly by the diffusion of Zn in the ZnO film 140) under a portion where the ZnO film 140 is formed by first annealing (at 520° C. for two hours), the window portion 131 and the window portion 132 that have the MQW layer 106W where the distribution of Al, Ga and In are disordered (intermixed) are formed.

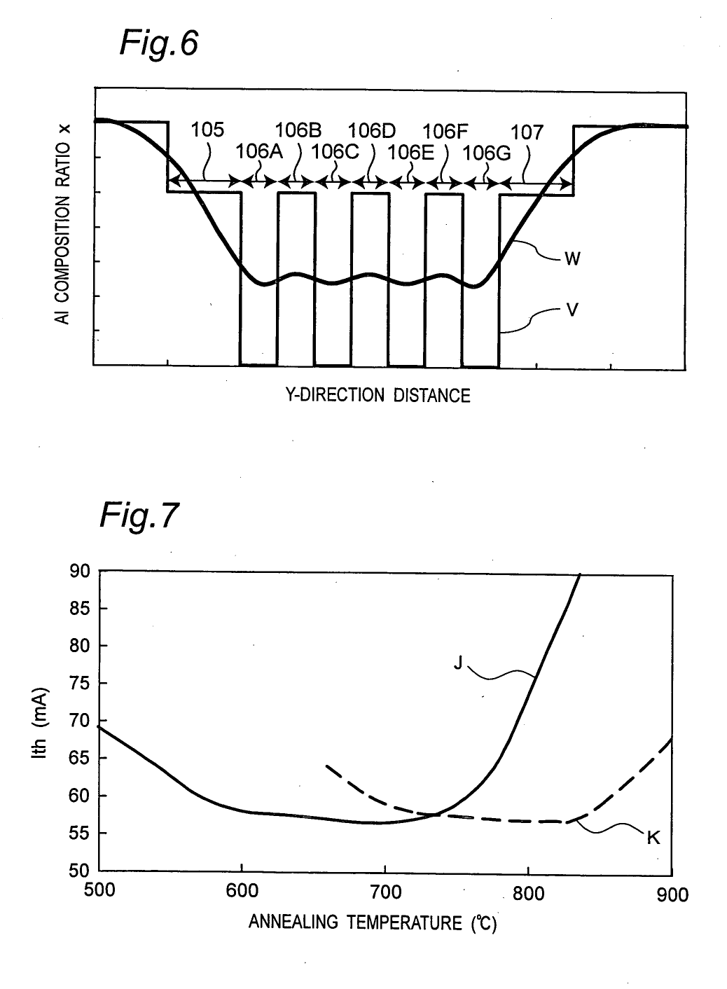

The disordering of the quantum well layers (106A, 106C, 106E, 106G) in the window portion 131 and the window portion 132 and the barrier layers (106B, 106D, 106F) is described. In FIG. 6, the horizontal axis represents the distance in the Y-direction (layer thickness direction), and the vertical axis represents the Al composition ratio x of the (AlₓGa₁₋ₓ)_{0.5}In_{0.5}P material. The line V indicates an Al composition ratio distribution in the quantum well layer and its neighborhood when no window structure is formed, and the line W indicates an Al composition ratio distribution in the quantum well layer and its neighborhood when a window structure is formed. As described above, the window portion serves as the MQW layer 106W that has an Al composition ratio x distribution W in which the quantum well layers 106A, 106C, 106E and 106G are intermixed with the lower guide layer 105, the barrier layers 106B, 106D and 106F and the upper guide layer 107. The optical absorption wavelength end becomes transparent since it comes to have a short wavelength when the Al composition ratio x is increased. For example, when the Al composition ratio x is 0.25, the optical absorption wavelength end comes to have a wavelength about 50 nm shorter than when the Al composition ratio x is zero, and therefore, the wavelength end becomes transparent with respect to the oscillation wavelength. Therefore, optical absorption at the light-emitting end surface is reduced. Although the MQW layer 106 has originally been undoped, a p-type dopant of a high atomic concentration (e.g., not lower than 2×10¹⁸ cm⁻³) enters the MQW layer 106W in the window portion 131 and the window portion 132 through the step.

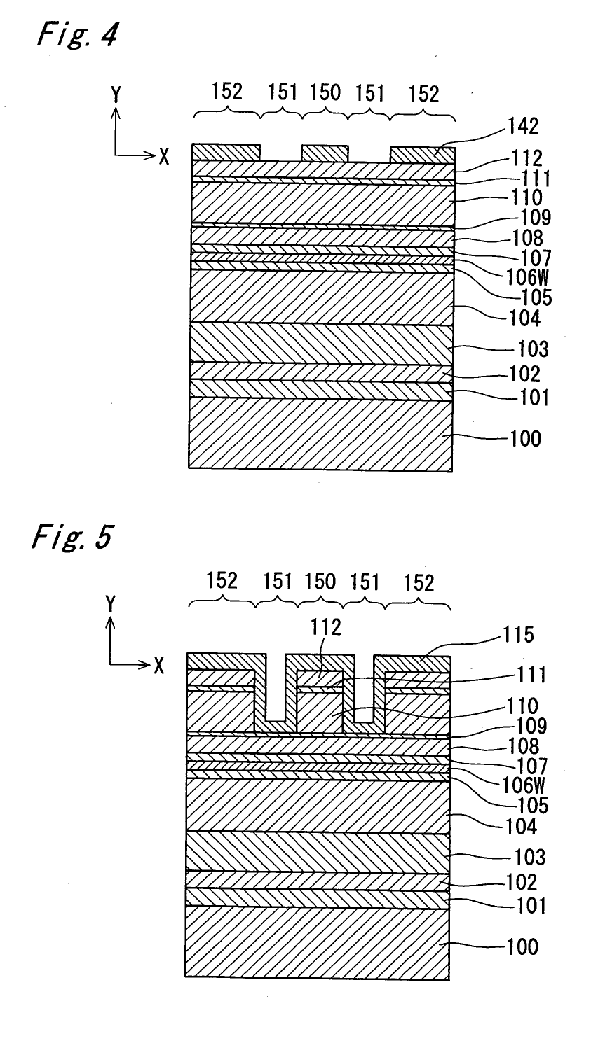

After the ZnO film 140 and the SiO₂ film 141 are removed, an SiO₂ film 142 is formed by photolithography on an upper part of the portions that become the ridge region 150 and the terrace region 152 as shown in FIG. 4 that is a sectional view taken along the line III-III of the semiconductor laser shown in FIG. 1 in a manufacturing process, and the ridge side region 151 is etched to the etching stop layer 109 using the film as a mask. As a result, the ridge region 150 of a width of about 2 μm is formed as shown in FIG. 5. The SiO₂ cover layer 115 is formed on the entire surface.

Second annealing is carried out at a temperature of 680° C. for two hours in a state in which the ZnO film 140 and the SiO₂ film 141 are removed. As a result, the p-type dopant (Mg of the dopant in the first upper cladding layer 108 and the second upper cladding layer 110 moved by being induced chiefly by the diffusion of Zn in the ZnO film 140) that causes disordering in the window portion 131 and the window portion 132 diffuses, and this reduces the atomic concentration (e.g., not higher than 7×10¹⁷ cm⁻³) in the MQW layer 106 of the p-type dopant and its neighborhood. As a consequence of the reduction in the optical absorption due to the existence of the excessive p-type dopant, an increase in the oscillation threshold current caused by an increase in the window length as described in the non-patent document 1 became not observed. FIG. 7 shows the relation between the second annealing temperature and the oscillation threshold current. The curve J indicates the case where the second annealing time is two hours, and the curve K indicates the case where the second annealing time is one minute. The oscillation threshold current is not greater than 60 mA at a temperature of not lower than 570° C. and not higher than 750° C. in the case of the curve J, and the oscillation threshold current is not greater than 60 mA at a temperature of not lower than 700° C. and not higher than 850° C. in the case of the curve K, which are suitable. Moreover, the temperature should suitably be not lower than 600° C. and not higher than 740° C. in the case of the curve J, and the temperature should suitably be not lower than 730° C. and not higher than 840° C. in the case of the curve K. When the second annealing temperature is lower than the range, an increase in the threshold value is caused by the excessive p-type dopant in the window portion. When the second annealing temperature is higher than the range, an increase in the oscillation threshold current is caused since the diffusion of the p-type dopant into the MQW layer 106 occurs in the non-window portion 133. It is noted that a tendency almost equivalent to the curve J of FIG. 7 is obtained when the second annealing time is within the range of one to four hours.

After the second annealing step, the SiO₂ cover layer 115 is removed from on the ridge region 150 in the non-window portion 133. It is noted that a useless current is prevented from flowing in the window portion 131 and the window portion 132 since the SiO₂ cover layer 115 that is the insulator remains being formed on the p-type GaAs cap layer 112.

After the formation of the n-side electrode 120 and the p-side electrode 121 shown in FIG. 2, the wafer is divided by crystal cleavage at the window portion 131 and the window portion 132, and the front antireflection coating 157 and the rear reflection coating 158 are formed on the obtained light-emitting end surface 155 and the rear end surface 156, respectively. By dividing the laser into chips, mounting each chip on a stem and bonding lead wires, a semiconductor laser element is completed.

(Characteristics of Semiconductor Laser of Embodiment 1)

The semiconductor laser of the present embodiment has the following characteristics. Since θv=11° and θh=10° were able to be obtained at an optical output of 100 mW, an ellipticity of 1.1 was able to be achieved. Moreover, the oscillation wavelength was 660 nm, and the oscillation threshold current was 57 mA. Moreover, θv=110 and θh=10.50 at an optical output of 240 mW by pulse drive (pulsewidth: 50 ns, duty cycle: 50%).

(Relation between Window Length L₁ and Vertical Radiation Angle of Embodiment 1)

In order to describe the phenomenon that the vertical radiation angle changes depending on the window length L₁ in the window portion 131, simulation by the BPM method (Beam Propagation Method) was carried out. In the case, the present inventor paid attention to the relation between the Al composition ratio and the refractive index. Conventionally, it has been considered that the refractive index n of the (AlₓGa₁₋ₓ)_{0.5}In_{0.5}P material has changed almost linearly with respect to the Al composition ratio x. In this case, the weighted average of the refractive indices of the layers 106A to 106G in the MQW layer 106 before the formation of the window portion or in the non-window portion becomes almost equal to the refractive index of the MQW layer 106W after the formation of the window portion. Therefore, the vertical distribution shapes of the guided wave 160 in the non-window portion 133 shown in FIG. 2 and the guided wave 160W in the window portion 131 become almost identical, and the vertical radiation angle transformation effect in the window portion does not appear. On the contrary, the present inventor presumed that the vertical radiation angle transformation effect in the window portion possibly occurs since the window portion and the non-window portion have different refractive indices if the relation between the refractive index n and the Al composition ratio x is not linear. Accordingly, the present inventor obtained in concrete the relation between the Al composition ratio x and the refractive index on the basis of the numerical expressions and parameters described in the reference document listed below implying that the relation between the wavelength and 1/(n²−1) had a nonlinearity.

Reference Document: Yawara Kaneto and Katsumi Kishino, “Refractive indices measurement of (GaInP)ₘ/(AlInP)ₙ quasi-quaternaries and GaInP/AlInP multiple quantum wells”, Journal of Applied Physics, Volume 76, No. 3, 1994, page 1815
E_{Γ}=(E₀−A)/B, where A=2.79 and B=0.728 Equation (2)
E₀=4.17−0.49x Equation (3)
E_{d}=35.79−1.16x Equation (4)
Eₚ=1240/λ Equation (5)
where λ is light wavelength (nm), and
E_{Γ}, E₀, E_{d} and Eₚ are in the unit of eV (electron volt).

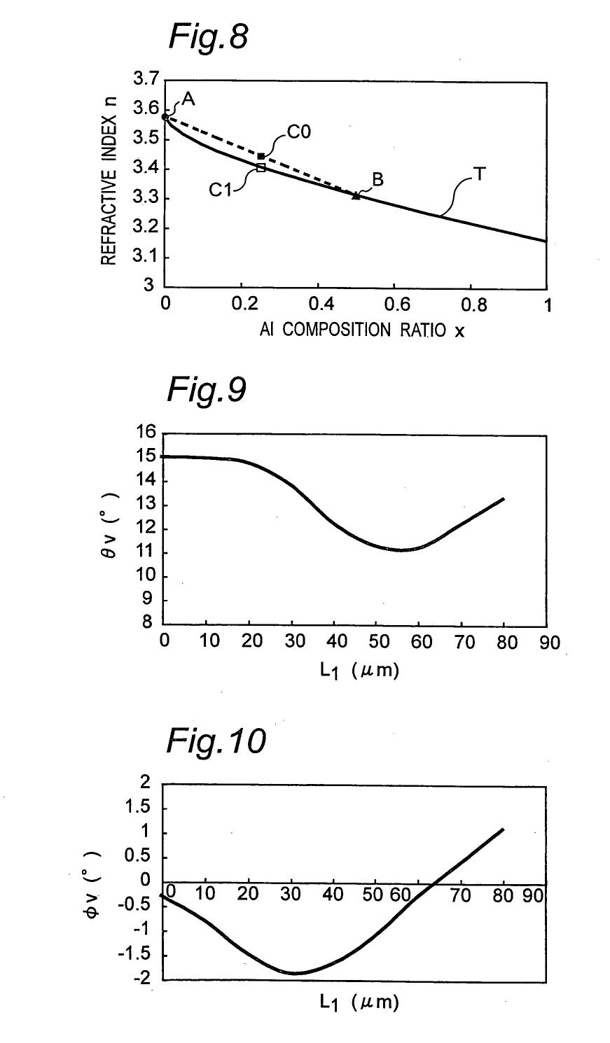

The relation between the Al composition ratio x and the refractive index n that the present inventor obtained is indicated by T in FIG. 8. In FIG. 8, A represents the refractive index of the quantum well layer, and B represents the refractive index of the barrier layer. Although the quantum well layer and the barrier layer independently exist in the MQW layer 106 in the non-window portion 133, calculation can be achieved considering that a layer of a refractive index of the weighted average of the two exists since the layer thickness is small. In the case, the refractive index becomes located at the point C0. On the other hand, since the quantum well layer and the guide layer are actually disordered (intermixed) in the MQW layer 106W in the window portion 131, the refractive index C1 along the curve T results.

According to the simulation, on the assumption that the refractive index of the MQW layer 106 in the non-window portion 133 was C0 and the refractive index of the MQW layer 106W in the window portion 131 was C1, the relation between the window length (horizontal axis) and the vertical radiation angle (vertical axis) shown in FIG. 9 was able to be derived. The angle θv took a smallest value of 11° at a window length of 60 μm, and this almost coincided with the actually measured value. In this case, since the calculated value of the vertical radiation angle when the window length is 0 μm is 15°, a difference between θv(non-window portion) of the non-window portion and θv of the window portion is 4°. It is proper to change the cleavage position in forming the light-emitting end surface 155 of the semiconductor laser and perform cleavage in the non-window portion in order to actually measure θv(non-window portion) corresponding to the guided wave 160 in the non-window portion. The maximum optical output in the case becomes lower than when the window portion exists.

(Relation between Window Length L₁ and Vertical Axial Deviation Angle φv in Embodiment 1)

With regard to the shape of the radiation light, it is desirable that the vertical axial deviation angle φv is almost zero and the vertical radiation light shape (shape of intensity distribution of radiation light in the vertical direction) is close to the Gaussian distribution shape, besides the fact that θv is close to θh.

FIG. 10 shows the relation between the window length L₁ and the vertical axial deviation angle φv (angle between the direction perpendicular to the light-emitting end surface 155 and a direction of a peak of intensity distribution of radiation light in the vertical direction). Although the absolute value of φv deviates by 1° or more when the window length is short, the vertical axial deviation angle φv becomes almost zero at 60 μm of the window length. Since the window length also has a value with which θv becomes minimum, the laser can suitably be used as a laser for optical disks.

(Relation between Lower Cladding Layer Structure and Deviation of Vertical Radiation Light shape from Gaussian Distribution Configuration in Embodiment 1)

In the present embodiment, in order to put the vertical radiation light shape close to the Gaussian distribution shape (shape such that the light intensity with respect to the angle θ is expressed by Gaussian distribution formula exp(−(θ/C)²), C is a constant), the lower cladding layer is separated into the first lower cladding layer 103 and the second lower cladding layer 104.

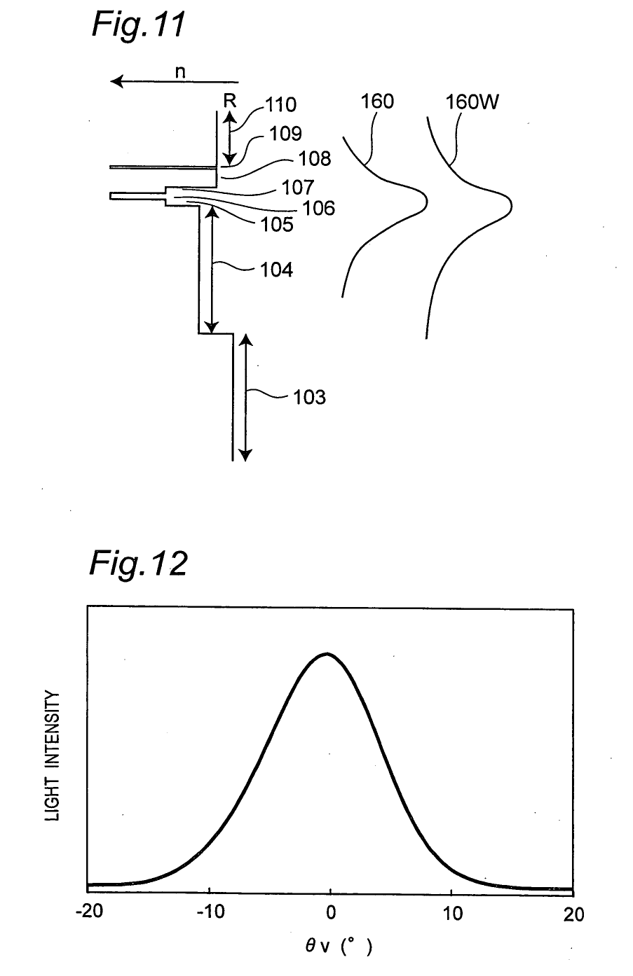

FIG. 11 shows a refractive index distribution R in the Y-direction, a light intensity distribution in the Y-direction of the guided wave 160 in the non-window portion 133 and a light intensity distribution in the Y-direction of the guided wave 160W at the light-emitting end surface 155. In contrast to the fact that the refractive index of the second lower cladding layer 104 on the side near the MQW layer 106 is set so that n=3.264 (PL wavelength 2=533 nm), the refractive index of the first lower cladding layer 103 on the side remote from the MQW layer 106 is set so that n=3.251 (PL wavelength 1=527 nm). In the present embodiment, by making the second lower cladding layer 104 have a very large thickness of 2.5 μm, the first lower cladding layer 103 of a low refractive index is arranged in a region where the guided wave 160 does not spread in effect in the non-window portion. Moreover, the refractive index of the first lower cladding layer 103 is made lower than the refractive index n=3.258 (PL wavelength 3=530 nm) of the first upper cladding layer 108 and the second upper cladding layer 110. According to the conventional thought, since the spread of the guided wave 160 in the non-window portion 133 is almost equal to the spread of the guided wave 160W in the window portion 131. Therefore, in the construction in which the first lower cladding layer is made sufficiently thick, the first lower cladding layer 103 has been regarded as substantially not existing. However, in the present invention, it is presumed that the guided wave 160W in the window portion 131 of FIG. 11 spreads more largely in the vertical direction than the guided wave 160 in the non-window portion 133 because the relation between the refractive index and the Al composition ratio has the nonlinearity shown in FIG. 8. In the case, the first lower cladding layer 103 in which the refractive index is low and the light distribution scarcely spreads moderately suppresses the spread of the light distribution, and this adjusts the vertical radiation light shape and putting the shape close to the Gaussian distribution shape. The simulation result of the vertical radiation light shape is shown in FIG. 12.

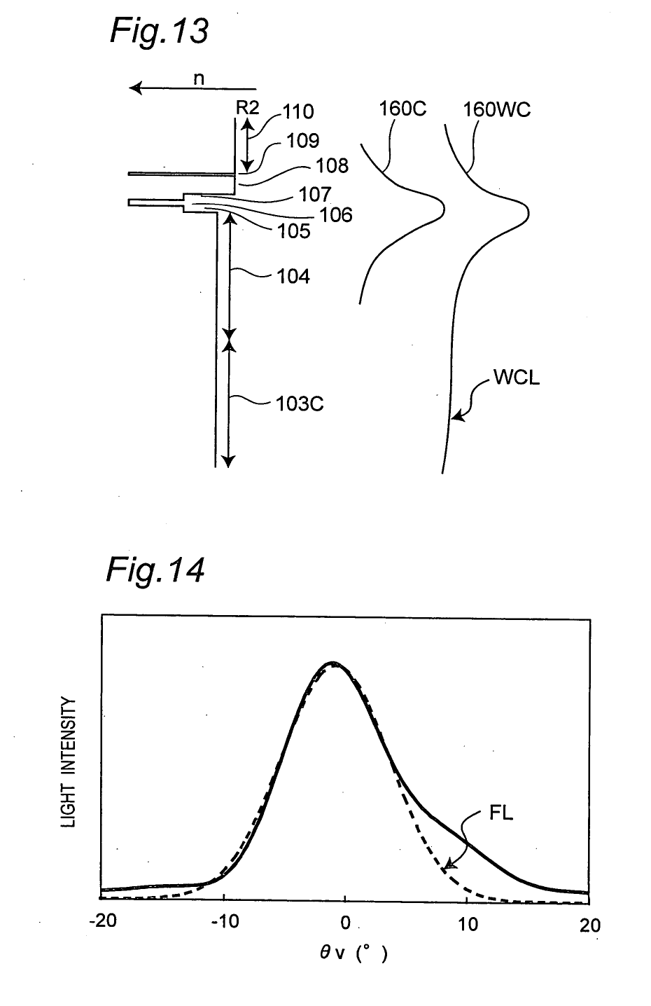

As a comparative example, FIG. 13 shows a refractive distribution R2 when the lower cladding layer is assumed to be 103C (when the refractive index of the first lower cladding layer 103 is equal to the refractive index of the second lower cladding layer 104), the light intensity distribution in the Y-direction of the guided wave 160C in the non-window portion 133 in the case and a light intensity distribution in the Y-direction of the guided wave 160WC at the light-emitting end surface 155. The guided wave 160WC has a widely skirted portion indicated as WCL, and the radiation light shape deviates from the Gaussian distribution shape due to the component. A simulation result of the vertical radiation light shape is indicated by the solid line of FIG. 14, and the Gaussian distribution shape is indicated by the dashed line fit to the solid line. In the comparative example, the skirt portion FL of the vertical radiation light shape largely deviates from the Gaussian distribution shape. It can be understood that the radiation light shape is largely improved by setting the refractive index of the first lower cladding layer 103 to the value of Embodiment 1 as shown in FIG. 12.

The distance between the first lower cladding layer 103 and the lower guide layer 105 (equal to the thickness of the second lower cladding layer 104 in the present embodiment) should properly be not smaller than 1.5 μm and not greater than 3.5 μm and more desirably be not smaller than 2.0 μm and not greater than 3.0 μm. Since light enters the first lower cladding layer 103 in the non-window portion when the distance is smaller than 1.5 μm, it is difficult to reduce θv. Conversely, the first lower cladding layer 103 is regarded as substantially not existing also in the non-window portion when the distance exceeds 3.5 μm, and it becomes difficult to put the radiation light shape close to the Gaussian distribution shape. Moreover, the PL wavelength 1 has been made shorter than the PL wavelength 2 by 6 nm. There is the effect of putting the radiation light shape close to the Gaussian distribution shape when the former is shorter than the latter by 2 nm or more, and the thickness should desirably be not smaller than 4 nm. An upper limit of the PL wavelength is about 50 nm shorter in wavelength, which is the case of the first lower cladding layer 103 made of Al_{0.5}In_{0.5}P.

Moreover, the PL wavelength 1 has been made shorter than the PL wavelength 3 by 3 nm or more. There is the effect of putting the radiation light shape close to the Gaussian distribution shape since there is a function of limiting the entry of the guided wave 160W into the first lower cladding layer 103 when the PL wavelength 1 is shorter than the PL wavelength 3 by 2 nm or more.

### EMBODIMENT 2

(Structure of Semiconductor Laser of Embodiment 2)

The point that the structure of Embodiment 2 differs from that of Embodiment 1 is described. In Embodiment 2, in reference to FIG. 1 that is the top view, the window lengths L₁ and L₂ are set to 70 μm. Moreover, in reference to FIG. 2 that is the sectional view, the undoped MQW layer 106 is formed by alternately layering six 3-nm thick Ga_{0.43}In_{0.57}P quantum well layers (106A, 106C, 106E, 106G, 106I, 106K) and five 5-nm (Al_{0.52}Ga_{0.48})_{0.5}In_{0.5}P barrier layers (106B, 106D, 106F, 106H, 106J). The lower guide layer 105 and the upper guide layer 107 were made to have a thickness of 0.005 μm.

In Embodiment 2, by changing the quantum well layers in the undoped MQW layer 106 into 106A, 106C, 106E, 106G, 106I and 106K of which the layer thickness is 3 nm and increasing the number of quantum well layers from four to six, the sum quantum well layer thickness is made almost equalized, so that the optical confinement coefficient is almost equalized. Moreover, since the quantum effect became remarkable by reducing the layer thickness of the quantum well layer, the amount of the compressive strain of the quantum well layer was increased by increasing the In composition ratio y of the Ga_{1-y}In_{y}P quantum well layer, so that the laser oscillation wavelength was equalized.

(Characteristics of Semiconductor Laser of Embodiment 2)

The angle θv was able to be reduced to 9.5° at an optical output of 100 mW further than in Embodiment 1. Since θh=9.5°, an ellipticity of 1.0 was able to be achieved. The threshold current value was 63 mA. In this case, the calculated value of the vertical radiation angle in the non-window portion (when the window length is 0 μm) is 13.3°, and the difference between θv of the non-window portion (non-window portion) and θv of the window portion is 3.8°.

(Description of Increase in Variation of Vertical Radiation Angle in Window Portion in Semiconductor Laser of Embodiment 2)

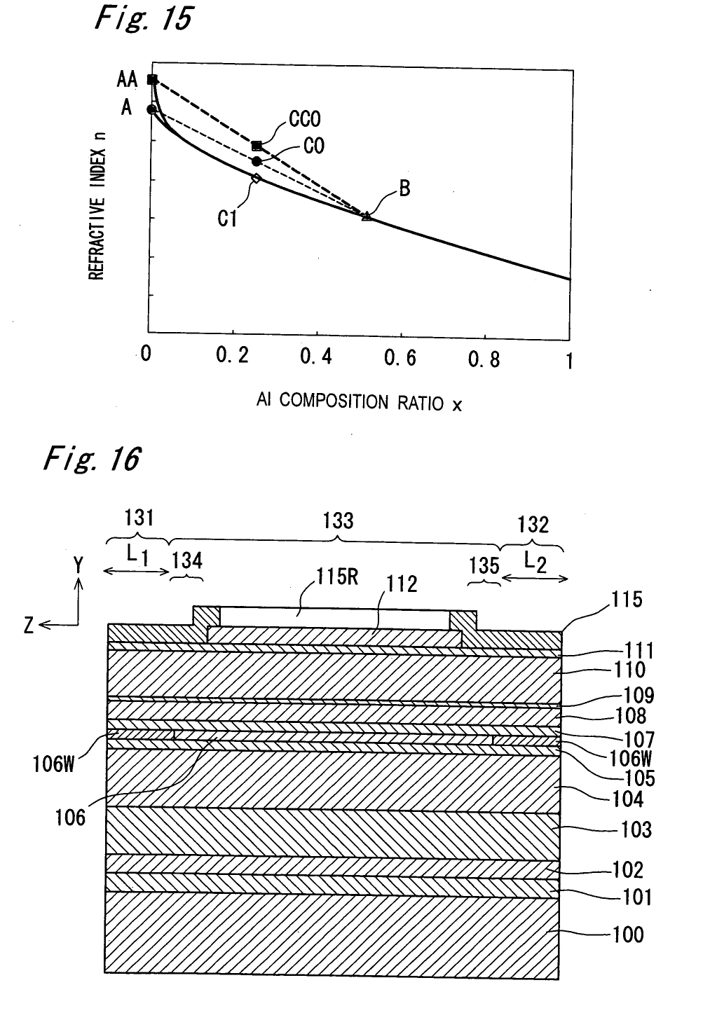

In FIG. 15, a refractive index AA when the quantum well layer is made thin is added (difference to the refractive index A is emphatically indicated) with respect to FIG. 8. Since the refractive index is changed from A in Embodiment 1 to AA, the refractive index with respect to the average Al composition ratio in the non-window portion 133 is changed into CC0. On the other hand, the refractive index in the window portion 131 is C0, which is scarcely changed. Therefore, the change in the refractive index of the MQW layer sensed by the light that propagates from the non-window portion 133 to the window portion 131 becomes the difference between CC0 and C1, which is greater than the difference between C0 and C1. Therefore, θv can be reduced further than when the quantum well layer thickness is large.

In order that a certain difference between the refractive indices C0 or CC0 of the MQW layer in the non-window portion and C1 is produced and a transformation of the vertical radiation angle between the non-window portion and the window portion occurs, the quantum well layer thickness should desirably be not greater than 6.5 nm and more desirably be not greater than 5.5 nm. On the other hand, the lower limit of the preferable quantum well layer thickness is considered to be 2.5 nm from the viewpoint of manufacturing variation. Since the quantum effect becomes remarkable at this degree, the laser oscillation wavelength comes to change with a slight change in the layer thickness, and the manufacturing variation increases. Moreover, it is necessary to make the total quantum well layer thickness almost constant by increasing the number of quantum well layers when the quantum well layer thickness is reduced. However, since the numbers of quantum well layers and the barrier layers are increased, the oscillation threshold current increases in accordance with an increase in the non-radiative recombination at the interface. Therefore, the quantum well layer thickness should desirably be not smaller than 2.5 nm and more desirably be not smaller than 3 nm.

### EMBODIMENT 3

(Structure of Semiconductor Laser of Embodiment 3)

The point of the structure of Embodiment 3 different from that of Embodiment 1 is described. In Embodiment 3 as shown in FIG. 16 that is a sectional view in a manufacturing process, the window lengths L₁ and L₂ are set to 50 μm. Moreover, extended current non-injection regions 134 and 135 are provided as described later. The undoped MQW layer 106 is formed by alternately layering three 6-nm thick Ga_{0.48}In_{0.52}P quantum well layers (106A, 106C, 106E) and two 5-nm thick (Al_{0.52}Ga_{0.48})_{0.5}In_{0.5}P barrier layers (106B, 106D). The thickness of the lower guide layer 105 and the upper guide layer 107 was set to 0.015 μm.

(Manufacturing Method of Semiconductor Laser of Embodiment 3)

The point of the manufacturing method of Embodiment 3 different from that of Embodiment 1 is described. First annealing is carried out in the state of the manufacturing process shown in FIG. 3. In the step, the atomic concentration of the p-type dopant in the p-type GaAs cap layer 112 is highly set to 1×10¹⁹ cm⁻³ in terms of the set value, and a higher atomic concentration results since Zn is supplied from the ZnO film 140 by the first annealing. After the ZnO film 140 and the SiO₂ film 141 are removed, an SiO₂ film 142 is formed by photolithography on the upper part of the portions that become the ridge region 150 and the terrace region 152 as shown in FIG. 4 that is a sectional view taken along the line III-III of the semiconductor laser shown in FIG. 1. Then, the ridge side region 151 is etched to the etching stop layer 109 with the film used as a mask.

Subsequently, as shown in FIG. 16 that is a sectional view taken along the line IV-IV of the semiconductor laser, the p-type GaAs cap layer 112 in the window portion 131 and the window portion 132 is removed, and the SiO₂ cover layer 115 is formed on the entire surface (whose portion to be subsequently removed serving as an SiO₂ cover layer 115R).

In the state shown in FIG. 16, second annealing is carried out at a temperature of 680° C. for two hours. As a result, the p-type dopant of a high atomic concentration in the p-type GaAs cap layer 112 does not diffuse to the MQW layer 106W in the window portion at the time of the second annealing, and therefore, it becomes easy to lower the p-type dopant concentration in the MQW layer 106W.

The SiO₂ cover layer 115R is removed after the second annealing, and a p-side electrode 121 is formed there, consequently allowing a current to be injected.

The regions 134 and 135 are extended current non-injection region. In Embodiment 1, the SiO₂ cover layer 115 has been formed on the p-type GaAs cap layer 112 in the window portion 131 and the window portion 132, blocking the current injection region. In Embodiment 3, the useless current flowing through the window portions 131 and 132 is further reduced by providing the regions 134 and 135 in which the current non-injection region is extended by 10 μm from the window length L₁. The length of the region 134 or the region 135 should desirably be about 5 μm to 20 μm.

(Characteristics of Semiconductor Laser of Embodiment 3)

The angle θv was 13.5° at an optical output of 100 mW. Since θh=10°, the ellipticity became 1.35. The threshold current value was 51 mA. At this time, the calculated value of the vertical radiation angle in the non-window portion (when the window length is 0 μm) is 17°, and a difference between θv(non-window portion) of the non-window portion and θv of the window portion is 3.5°.

(Relation between Window Length and Vertical Radiation Angle in Embodiments 1, 2 and 3)

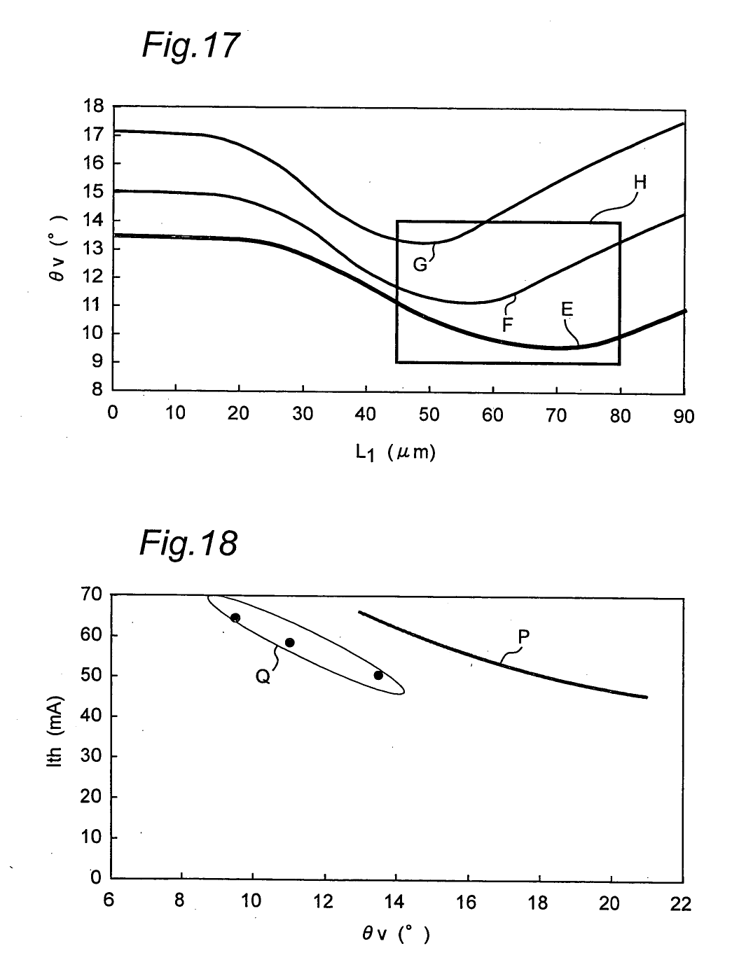

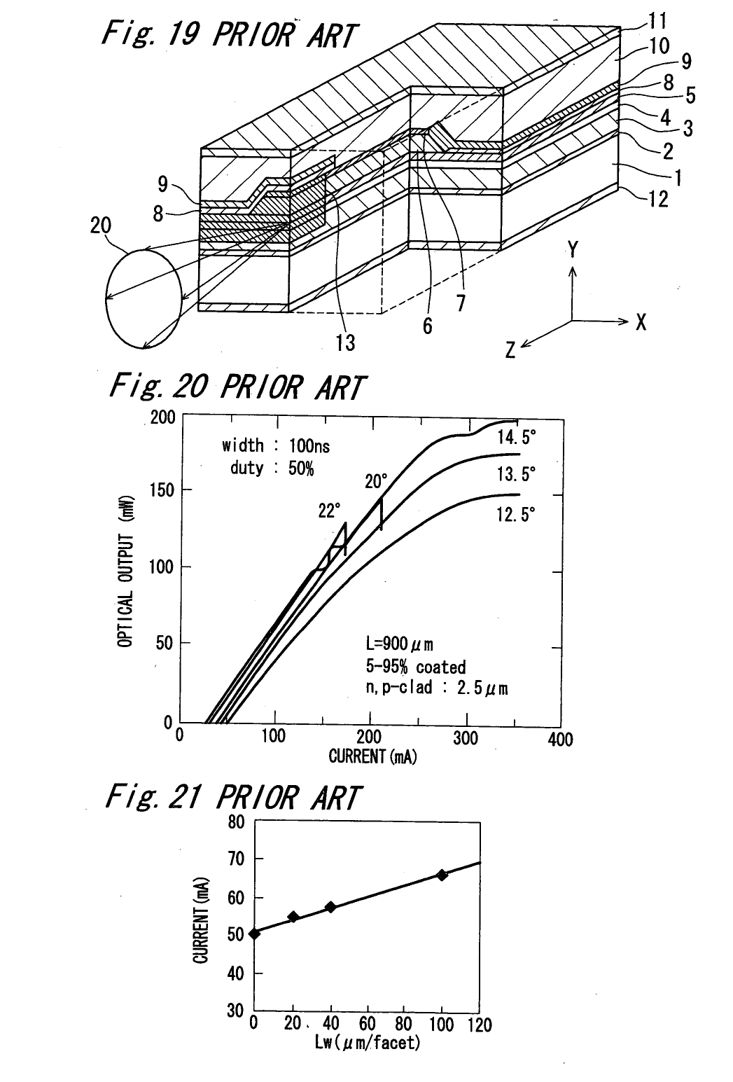

FIG. 17 shows the simulation results of the window length (horizontal axis) and the vertical radiation angle (vertical axis), the results being indicated by F in the case of Embodiment 1, E in the case of Embodiment 2 and G in the case of Embodiment 3. Paying attention to the window length at which θv takes the smallest value, it can be understood that the window length becomes longer as the smallest value of θv is reduced. The region H is the region of the window length and θv where the remarkable effect of the present invention is produced.

(Relation between Vertical Radiation Angle and Oscillation Current in Embodiments 1, 2 and 3)

FIG. 18 shows the relation between the vertical radiation angle θv and the oscillation threshold current Ith, in which P represents the conventional case where the window length is set constant at 20 μm (simulation result), Q represents the cases of Embodiment 1, Embodiment 2 and Embodiment 3 where the window length is optimized in conformity to θv. In the present invention, θv can be reduced while suppressing an increase in the oscillation threshold current by increasing the spread of the vertical light intensity distribution of the guided wave 160W at the light-emitting end surface 155 with respect to the vertical light intensity distribution of the guided wave 160 in the non-window portion 133 shown in FIG. 2.

(Modification Example of Semiconductor Laser of Embodiments 1, 2 and 3)

The present invention can be modified as follows.

Although the wafer has been divided by crystal cleavage at the window portion 131 and the window portion 132 in order to form the light-emitting end surface 155 and the rear end surface 156, it is acceptable to divide the wafer by the dicing method or the like after forming a light-emitting end surface by the dry etching method or the like.

Although the silicon oxide has been used as the cover layer 115, a dielectric of silicon nitride or the like may be used. Moreover, it is acceptable to form a semiconductor current blocking layer of a layer where n-type GaAs is provided on n-type AlInP, n-type GaAs or n-type AlInP or the like. In the case, the guided wave shape in the horizontal direction is stabilized since the refractive index difference to the second cladding layer is reduced. Moreover, since a reduction in the thermal expansion coefficient difference can be achieved, it is possible to make the characteristic deterioration hardly occur due to heat treatment during processing.

It is also acceptable to provide a structure in which an electrode is formed directly on the etching stop layer or the second upper cladding layer by eliminating the cover layer. In the case, it can be considered that the electrode concurrently serves as a cover layer.

Although the window length L₁ of the window portion 131 on the light-emitting end surface 155 side has been made equal to the window length L₂ of the window portion 131 on the rear end surface 156 side, L₂ is allowed to have a value different from that of L₁ and allowed to be, for example, 20 μm. When L₂ becomes shorter, there is an advantage that heat radiation becomes satisfactory since the non-window portion 133 that contributes to current injection becomes long, and the optical loss in the window portion on the rear end surface 156 side is reduced.

Although the window portion 131 and the window portion 132 have been formed in all of the ridge region 150, the ridge side region 151 and the terrace region 152 as shown in FIG. 1, the same effect is obtained also by forming the window portions only in the ridge region 150 and the ridge side region 151 located in its neighborhood, which constitutes the optical waveguide.

The first lower cladding layer 103, the second lower cladding layer 104, the first upper cladding layer 108 and the second upper cladding layer 110 may further be divided into a multiplicity of layers, and the Al composition ratio may be nonuniform. So long as the average Al composition ratio in each layer is almost equal to that of the present embodiment even when it is nonuniform, an almost similar vertical radiation angle is obtained.

When the device is used as a mere excitation light source instead of optical disk use, it is acceptable to use a high-power laser in which the optical waveguide width of the ridge region 150 is widely set to, for example, 50 μm, and the transverse mode (guided wave shape in the X-direction) performs multimode oscillation.

Although the lower guide layer 105 and the upper guide layer 107 have had same thickness, it is acceptable to make the lower guide layer thin and make the upper guide layer thick or conversely make the lower guide layer thick and make the upper guide layer thin.

Although the undoped MQW layer 106 has included the plurality of, or three, four or six quantum well layers, the quantum well layer may be single. The layer may be slightly doped (e.g., p atomic concentration=1 to 5×10¹⁷ cm⁻³) instead of being undoped.

Although the Al composition ratio and the In composition ratio of the lower guide layer and the upper guide layer and the barrier layer have been made same, it is acceptable to vary the Al composition ratio or the In composition ratio of the guide layers and the barrier layer.

As the dopant of the n-type first lower cladding layer and the n-type second lower cladding layer, Se can be used besides Si.

As the dopant of the p-type first upper cladding layer, the p-type second upper cladding layer and the p-type GaAs cap layer, Be, Zn or the like can be used besides Mg. It is general to form each compound semiconductor layer by using the MBE (Molecular Beam Epitaxy) method when Be is used and using the MOCVD (Metalorganic Chemical Vapor Deposition) method when Mg or Zn is used.

As the formation method of the window portion, the so-called IILD method (Impurity Induced Layer Disordering) method of diffusing group-II atoms of Zn or the like and making the group-II atoms promote the diffusion of Ga in GaAs, Al, Ga or In in AlGaInP, thereby disordering the MQW layer was used. In this case, as a diffusion source, a p-type dopant diffusion film of, for example, oxide such as beryllium oxide, cadmium oxide, magnesium oxide and calcium oxide, sulfide such as zinc sulfide, beryllium sulfide, cadmium sulfide, magnesium sulfide and calcium sulfide, or single element of zinc, beryllium, cadmium, magnesium or calcium can be used in place of ZnO (zinc oxide). Moreover, the IFVD (Impurity Free Vacancy Disordering) method for forming a dielectric layer of an SiO₂ layer or the like on the window portion and utilizing the diffusion of holes of the group-V atoms (As, P etc.) at the time of heating or a method for effecting disordering by carrying out annealing after ion implantation may be used as the formation method of the window portion. The IFVD method has an advantage that the high-concentration p-type dopant is not accumulated in the MQW layer 106W in the window portion.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. An AlGaInP based window structure semiconductor laser device having an optical waveguide in which a lower cladding layer, an active layer having a quantum well layer, and an upper cladding layer are laminated in this order and which emits light from a light-emitting end surface that is formed on an end of the optical waveguide, wherein
a window portion having an active layer in which the quantum well layer is disordered is formed in an end portion including the light-emitting end surface in the optical waveguide,
a light intensity distribution in a vertical direction for the laminated layers in the window portion spreads further than a light intensity distribution in the vertical direction in a non-window portion which is adjacent to the window portion inside the optical waveguide, and
a length of the window portion from the light-emitting end surface to the non-window portion is not smaller than 48 μm and not greater than 80 μm.

2. The AlGaInP based window structure semiconductor laser device as claimed in claim 1, wherein
a vertical radiation angle which is defined corresponding to full width at half maximum of light intensity distribution in the vertical direction in the non-window portion is greater than a vertical radiation angle which is defined corresponding to full width at half maximum of light intensity distribution in the vertical direction of the light emitted from the window portion by not smaller than 3°.

3. The AlGaInP based window structure semiconductor laser device as claimed in claim 1, wherein
a vertical radiation angle which is defined corresponding to full width at half maximum of light intensity distribution in the vertical direction of the light emitted from the window portion is not smaller than 9° and not greater than 14°.

4. The AlGaInP based window structure semiconductor laser device as claimed in claim 1, wherein
an vertical axial deviation angle between a direction perpendicular to the light-emitting end surface and a direction of a peak of light intensity distribution in the vertical direction of the light emitted from the window portion is within a range from −1° to 1°.

5. The AlGaInP based window structure semiconductor laser device as claimed in claim 1, wherein
the quantum well layer has a layer thickness of not greater than 6.5 nm.

6. The AlGaInP based window structure semiconductor laser device as claimed in claim 1, wherein
a number of the quantum well layers is not smaller than four and not greater than six.

7. The AlGaInP based window structure semiconductor laser device as claimed in claim 1, wherein
the lower cladding layer is comprised of a first lower cladding layer located in a portion remote from the active layer and a second lower cladding layer located in a portion near the active layer, and
a photoluminescence wavelength of the first lower cladding layer is shorter than a photoluminescence wavelength of the second lower cladding layer by not smaller than 2 nm and not greater than 50 nm, and the second lower cladding layer has a thickness of not smaller than 1.5 μm and not greater than 3.5 μm.

8. The AlGaInP based window structure semiconductor laser device as claimed in claim 1, wherein
the lower cladding layer is comprised of a first lower cladding layer located in a portion remote from the active layer and a second lower cladding layer located in a portion near the active layer, and
a photoluminescence wavelength of the first lower cladding layer is shorter than a photoluminescence wavelength of the upper cladding layer by not smaller than 2 nm and not greater than 50 nm.

9. A method for manufacturing the AlGaInP based window structure semiconductor laser device claimed in claim 1, comprising:
a step of forming a wafer in which an n-type lower cladding layer, an active layer having a quantum well layer and a p-type upper cladding layer are successively laminated;
a step of forming a p-type dopant diffusion source on a surface of a portion of the wafer where the window portion is to be formed;
a first annealing step of forming the window portion by disordering the active layer that has the quantum well layer by means of diffusion of p-type dopant from the p-type dopant diffusion source;
a step of removing the p-type dopant diffusion source;
a second annealing step of making the p-type dopant diffuse so as to reduce the p-type dopant concentration at least in the active layer of the window portion; and
a step of forming the light-emitting end surface so that the window portion formed by the diffusion of the p-type dopant has a length of not smaller than 48 μm and not greater than 80 μm.

10. A method for manufacturing the AlGaInP based window structure semiconductor laser device claimed in claim 1, comprising:
a step of forming a wafer in which an n-type lower cladding layer, an active layer having a quantum well layer, a p-type upper cladding layer and a p-type cap layer are successively laminated;
a step of forming a p-type dopant diffusion source on a surface of the p-type cap layer of a portion of the wafer where the window portion is to be formed;
a first annealing step of forming the window portion by disordering the active layer that has the quantum well layer by means of diffusion of p-type dopant from the p-type dopant diffusion source;
a step of removing the p-type dopant diffusion source and the p-type cap layer in the window portion;
a second annealing step of making the p-type dopant diffuse so as to reduce the p-type dopant concentration at least in the active layer of the window portion; and
a step of forming the light-emitting end surface so that the window portion formed by the diffusion of the p-type dopant has a length of not smaller than 48 μm and not greater than 80 μm.

11. The method for manufacturing the AlGaInP based window structure semiconductor laser device claimed in claim 9, wherein
the quantum well layer has a layer thickness of not greater than 6.5 nm.

12. The method for manufacturing the AlGaInP based window structure semiconductor laser device claimed in claim 9, wherein
a number of the quantum well layers is not smaller than four and not greater than six.

13. The method for manufacturing the AlGaInP based window structure semiconductor laser device claimed in claim 9, wherein
a temperature in the second annealing step is not lower than 570° C. and not higher than 850° C.

14. The method for manufacturing the AlGaInP based window structure semiconductor laser device claimed in claim 10, wherein
the quantum well layer has a layer thickness of not greater than 6.5 nm.

15. The method for manufacturing the AlGaInP based window structure semiconductor laser device claimed in claim 10, wherein
a number of the quantum well layers is not smaller than four and not greater than six.

16. The method for manufacturing the AlGaInP based window structure semiconductor laser device claimed in claim 10, wherein
a temperature in the second annealing step is not lower than 570° C. and not higher than 850° C.
